(19) United States
(12) Patent Application Publication
(10) Pub. No.: US 2015/0217595 A1
(43) Pub. Date: Aug. 6, 2015

(54) PAINT CAN HANDLE

(71) Applicant: Simtastec, Carol Stream, IL (US)

(72) Inventors: Dominik Piatek, Carol Stream, IL (US); Sebastian Kieller, Chicago, IL (US); Lukasz Adam Kieller, Chicago, IL (US); Qiong Wu, Chicago, IL (US)

(21) Appl. No.: 14/615,986

(22) Filed: Feb. 6, 2015

Related U.S. Application Data
(60) Provisional application No. 61/936,683, filed on Feb. 6, 2014.

(51) Int. Cl. B44D 3/14

(52) U.S. Cl. CPC B44D 3/14

(57) ABSTRACT

Embodiments of the present disclosure include a can strap made of flexible material and configured for wrapping around an outer surface of an object. Further, such embodiments include a handle strap coupled to the can strap wherein the handle strap is configured for a grip.

### CROSS-REFERENCE TO RELATED APPLICATIONS

The present application is related to and claims benefit under 35 U.S.C. §119(e) from U.S. Provisional Patent Application Ser. No. 61/936,683 filed on Feb. 6, 2014, the entire contents of which is being incorporated herein by reference.

### BACKGROUND

Common paint is typically packaged in cans at a standard volume of one gallon, but with alternative cans ranging in size both larger and smaller sizes. The typical paint cans come equipped with a wire handle. Such a wire handle is inexpensive to manufacture and install, however, it tends to hurt the hand of a barehanded user who must carry the paint. A larger handle would spread the load of the paint more evenly on the hand reducing the concentrated weight and, by extension, pain in the hand when carrying the pain can. Moreover a durable reusable handle would permit users to benefit from a larger handle without affecting the end user cost of paint, which naturally includes the cost of the paint's packaging, including the handle.

Accordingly, there is a need for a paint can handle that offers a durable reusable handle that may gripped by hand or secured to a surface or object.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a front perspective view of a paint can with paint can handle, according to some embodiments.

FIG. 2 is a front perspective view of a paint can handle, according to some embodiments.

FIG. 3 is a side perspective view of a paint can with paint can handle, according to some embodiments.

FIG. 4 is a side perspective view of a paint can handle, according to some embodiments.

FIG. 5 is a perspective view of a paint can with paint can handle gripped by a hand, according to some embodiments.

FIG. 6 is a perspective view of a paint can with paint can handle secured to a surface of a ladder, according to some embodiments.

FIG. 7 is a perspective view of a paint can with paint can handle hanging from a ladder, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

Embodiments of the present disclosure include a can strap made of flexible material and configured for wrapping around an outer surface of an object. Further, such embodiments include a handle strap coupled to the can strap wherein the handle strap is configured for a grip. In some embodiments, the object may be substantially cylindrical such as a paint can such that the can strap is configured for wrapping around the circumference of the substantially cylindrical object. In further embodiments, the handle strap may be configured to couple to the can strap such that the handle strap is substantially perpendicular to the can strap. In other embodiments, the handle strap is further configured to couple to the can strap such that the handle strap is substantially parallel to a length of the object. In some embodiments, the grip is configured to accommodate a human hand. In other embodiments, the grip is configured to couple to a resting surface below the object. In additional embodiments, the grip is configured to couple to a resting surface below the object such that the object is secured to the resting surface. The resting surface may be a surface of a ladder. In further embodiments, the grip is configured to couple to a second object such that the first object is secured to the second object. In addition, the first object may be coupled to the second object such first object is hanging from the second object. Further, the object may be hung from a ladder. In some embodiments, the handle strap may be coupled to the can strap using Velcro material. In other embodiments, the handle strap may be coupled to the can strap using a buckle fastener. In additional embodiments, the handle strap is made of flexible material.

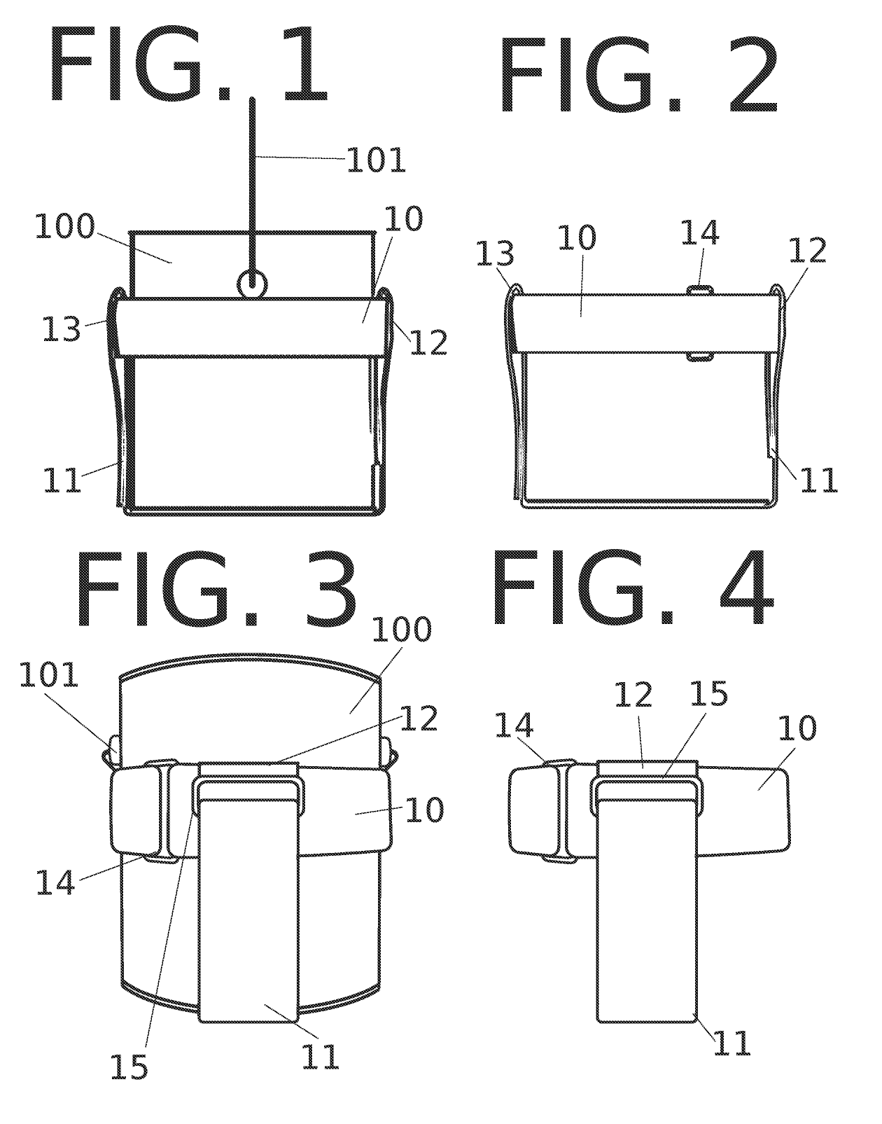

FIGS. 1-4 are perspective view of a paint can with paint can handle or a paint can handle alone, according to some embodiments. The handle is a reusable load spreading handle that may include a circumferential strap or can strap 10 surrounds the exterior or outer surface of the paint can 100 and is tightened in place by a circumferential strap cinch 14.

In some embodiments, the circumferential strap 14 may be a buckle or some other fastener known in the art. Further, the circumferential strap 10 may be closed by friction with the circumferential strap cinch 14 alone, or may further have compatible hook and loop (Veltro™) fasteners affixed to its exterior and interior surfaces, respectively.

A support strap or handle strap 11 is wrapped around the circumferential strap 10 at a first attachment loop 12 and a second attachment loop 13. In some other embodiments, the support or handle strap 11 may be coupled to the circumferential strap 10 by another fastener such Velcro, buckle, or other fasteners known in the art. The support cinch 15 is adjustable by a support strap cinch 15. In some embodiments, the support strap 11 may be a buckle or some other fastener known in the art. Further, with respect to the support strap 11, the first attachment loop 12 may be closed by the support strap cinch 15, optionally also with compatible hook and loop Velcro fasteners.

The second attachment loop 13 may be identical to the first attachment loop 12, including a duplication of the support strap cinch 15, or may be permanently closed around the circumferential strap 10, for example by stitching To use the embodiments of the disclosure, the user fits the circumferential strap 10 around the exterior of the paint can 100, tightens it using the circumferential cinch 14, and closes any hook and loop or other fasteners provided thereon.

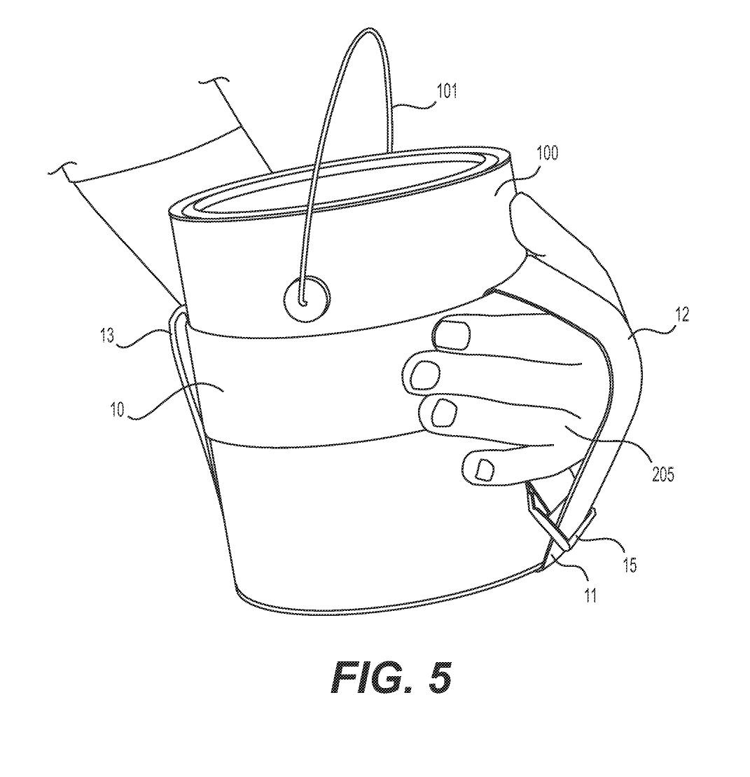

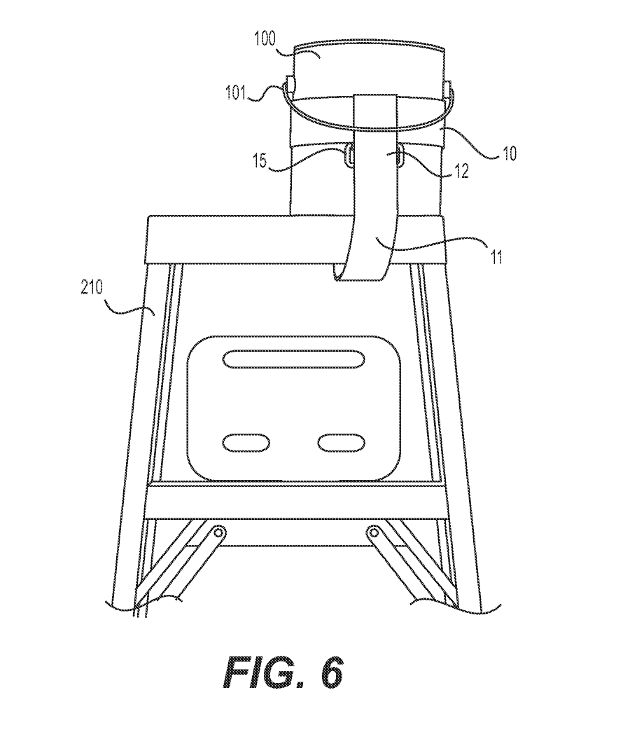

FIGS. 5-7 are perspective views of a paint can with paint can handle, according to some embodiments. In an embodiment, the user then tightens the support strap 11 underneath the paint can 100 using the support strap cinch 15 and any provided hook and loop or other fasteners. The user leaves enough slack to insert his or her hand between the overlap of the support strap 11 created by the first attachment loop 12 and support strap cinch 15. The user may then carry the paint can 100 conveniently with one hand without using the paint can handle 101. The support strap 10 may be wrapped under the paint can 100, thus supporting the can 100 from beneath while permitting the overlap region created by the support strap cinch 15 to provide a large handhold with distributed force across the user's hand whereby the user need not use and may remove the wire paint can handle 101. Such a handhold may be call a grip.

In another embodiment, the user tightens the support strap 11 about a convenient object, such as a ladder 210. The paint can may be positioned to hang from the support strap 11, for example on the side of the ladder 210 to hang, or may be placed upon the ladder step or other horizontal resting surface with the support 5 strap wrapped underneath and tightened, thereby securing the paint can 100 in place and providing a fixed support for the paint can.

The circumferential strap 10 and support strap 11 are preferably made of a durable flexible material, such as nylon weave, canvas, or leather. The circumferential strap cinch 14 and support strap cinch 15 are preferably made of a rigid durable material such as high impact plastic or steel. Components, component sizes, and materials listed above are preferable, but artisans will recognize that alternate components and materials could be selected without altering the scope of the invention.

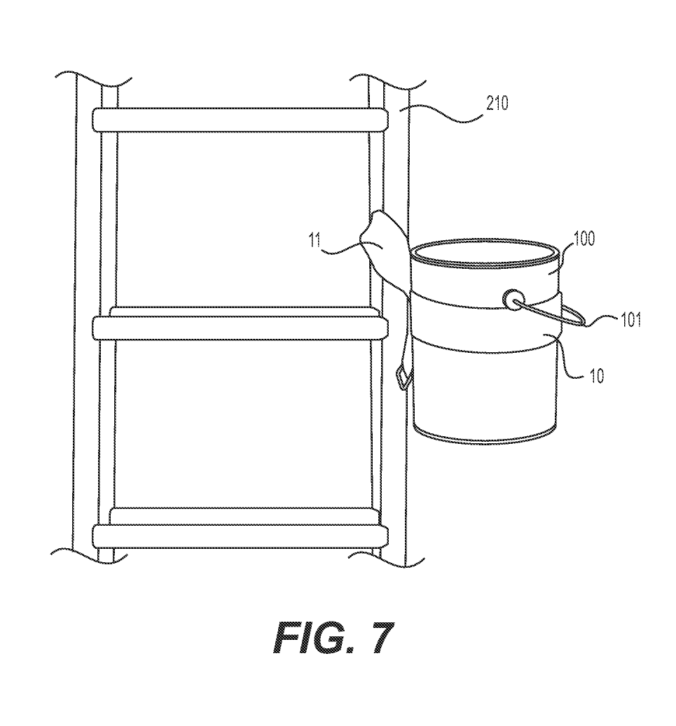

Although an exemplary embodiment depicted in FIGS. 1-7 shows the paint can handle that includes circumferential strap or can strap 10 and support strap or handle strap 11 is used in conjunction with a paint can 100, persons of ordinary skill in the art would understand that such a paint can handle may be used with other objects. Such objects may be substantially cylindrical in shape but other shapes of objects may be contemplated including but not limited to rectangular surfaces and prisms, trapezoidal surfaces and prisms and other non-circular surfaces and three-dimensional objects. Further, although in some embodiments the support strap 11 may be secured to the object or circumferential strap 11 in an orientation perpendicular to the circumferential strap 11 or parallel to length of the object, any orientation of the support strap 11 to the circumferential strap 10 may be contemplated such as the support strap 11 be along the top of an object such as a paint can and can be lifted by the support strap 11 from above the object/paint can like a wire handle. In addition, the object such as a paint can is able to be hung from another object such as a ladder 210 as shown in FIG. 7. However, in other embodiments, the paint can or object can be hung from any suitable object other than a ladder that the support the paint can or object.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An apparatus, comprising:
a can strap made of flexible material and configured for wrapping around an outer surface of a first object;
a handle strap coupled to the can strap wherein the handle strap is configured for a grip.

2. The apparatus of claim 1, wherein the first object is substantially cylindrical and the can strap is configured for wrapping around the circumference of substantially cylindrical first object.

3. The apparatus of claim 1, wherein the handle strap is further configured to couple to the can strap such that the handle strap is substantially perpendicular to the can strap.

4. The apparatus of claim 1, wherein the handle strap is further configured to couple to the can strap such that the handle strap is substantially parallel to a length of the first object.

5. The apparatus of claim 1, wherein the grip is configured to accommodate a human hand.

6. The apparatus of claim 1, wherein the grip is configured to couple to a resting surface below the first object.

7. The apparatus of claim 1, wherein the grip is configured to couple to a resting surface below the first object such that the first object is secured to the resting surface.

8. The apparatus of claim 1, wherein the grip is configured to couple to a second object such that the first object is secured to the second object.

9. The apparatus of claim 8, wherein the first object is coupled to the second object such first object is hanging from the second object.

10. The apparatus of claim 1, wherein the first object is a paint can.

11. The apparatus of claim 6, wherein the resting surface is a step of a ladder.

12. The apparatus of claim 8, wherein the second object is a ladder.

13. The apparatus of claim 1, wherein the handle strap is coupled to the can strap using Velcro material.

14. The apparatus of claim 1, wherein the handle strap is coupled to the can strap using a buckle fastener.

15. The apparatus of claim 1, wherein the handle strap is made of flexible material.

16. The apparatus of claim 1, wherein the can strap is secured to the first object using a cinch.

17. The apparatus of claim 16, wherein the cinch includes Velcro material.

18. The apparatus of claim 16, wherein the cinch includes the buckle.
